(19) United States
(12) Patent Application Publication
(10) Pub. No.: US 2006/0284409 A1
(43) Pub. Date: Dec. 21, 2006

(54) Photograph Album Having Base Tabs With Selectively Attached Locking Page Assemblies

(75) Inventor: Francis Gene Butler, Findlay, OH (US)

Correspondence Address: RANKIN, HILL, PORTER & CLARK, LLP, 925 EUCLID AVENUE, SUITE 700, CLEVELAND, OH, 44115-1405, US

(73) Assignee: THE CHILCOTE COMPANY, Cleveland, OH (US)

(21) Appl. No.: 11/160,252

(22) Filed: Jun. 15, 2005

(51) Int. Cl. B42D 1/00

(52) U.S. Cl. 281/15.1

(57) ABSTRACT

A photograph album is made up of a cover assembly, a plurality of base tabs, and a plurality of page assemblies. The cover assembly is formed by front and back covers. The base tabs are bound and attached to the cover assembly, and each of the base tabs has a support portion. The page assemblies are attached to the base tabs, with each of the page assemblies having a pocket adapted to receive the support portion of one of the base tabs and to lock the page assembly to the base portion. The album can be provided with multiple page assemblies of various designs and colors with photographs of other items attached to the surface, that can be selectively attached to the base tabs to customize the album as desired. Each of the page assemblies is selectively installed in the album and can be removed and replaced as desired, while the album gives the appearance of having pages that are permanently bound.

### FIELD OF INVENTION

The present invention relates to photo albums, and especially to albums of the type used by professional photographers to hold collections of photographs and possibly other items in a desired arrangement, and more particularly to the connection of album pages to the cover assembly.

### BACKGROUND OF THE INVENTION

Photo albums come in a wide variety of sizes and qualities. One important market for such albums is to professional photographers who use bound albums for the presentation of photograph collections they have been employed to produce. These photo albums are typically made of more expensive materials and display a superior construction, so that the finished product is presented in a quality setting. The most popular use of such albums is in the presentation of wedding photos, but the albums can also be used for collections of photographs for commercial presentations or for photos of other events, such as confirmations and graduations. Each of the photographs is typically mounted on an album page and permanently bound with other pages in the album cover.

Since the photographs presented to the customer usually have special significance, and since the customer has made a significant expenditure to obtain these photographs, it is important that the album used to display the photograph collection present them with a high-quality appearance, preferably similar to that of an expensively bound book. The use of a loose-page arrangement, such as commonly used in a notebook binder, presents a lower-quality and cheaper look, and generally is avoided. However, it is usually difficult and very expensive to provide the finished bound appearance to an album.

It is often desirable to customize each of the bound album pages for a particular purpose, such as to present special photographs in a specific order or to provide appropriate decoration or color-coordinated design on the album page. This is possible if the bound album is specially manufactured to order, which is prohibitively expensive, or if the photos are applied to a pre-bound album page. However, if the photos are applied to pages of a pre-bound album, there is no ability to correct mounting errors except by replacing the entire album, which is extremely expensive. The only alternative to avoid this expense is to make the album pages somehow selectable or replaceable by the photographer.

Various constructions have been proposed for selectively connecting album pages to the binding so that each of the album pages can be chosen for the desired arrangement of the album, and so that the selected album pages are bound in the desired order so as to present a complete finished album. Examples of such designs are shown in the following U.S. patents: U.S. Pat. No. 636,794, issued to Page; U.S. Pat. No. 1,530,230, issued to Brown; U.S. Pat. No. 4,140,565, issued to Parker et al.; U.S. Pat. No. 4,378,647, issued to Stancato; U.S. Pat. No. 4,601,489, issued to Stancato; U.S. Pat. No. 4,784,508, issued to Shannon; U.S. Pat. No. 4,907,904, issued to Baldwin; U.S. Pat. No. 4,916,838, issued to Holson; U.S. Pat. No. 4,934,739, issued to Stancato; U.S. Pat. No. 5,375,936, issued to Jennison et al.; U.S. Pat. No. 5,405,169, issued to Schwartz; U.S. Pat. No. 6,019,539, issued to Lynton; and U.S. Pat. No. 6,390,71 4, issued to Bradley et al.

The patents to Parker et al. and Bradley et al., for example, describe various methods to add and remove album pages from the spine, but the methods suffer in that intricate exposed binding constructions are provided which detract from the appearance of the album, or the album pages are not securely held in place, or complete flexibility of the album arrangement is not available to the provider of the album.

### SUMMARY OF INVENTION

The disadvantages of the prior art are overcome by the present invention of an album in which page assemblies can be attached to an album core comprising the cover assembly with permanently bound base tabs onto which the page assemblies slip and are locked in place. The page assemblies can be chosen and arranged at will and assembled with the album core to provide a finished high-quality appearing bound album which resembles one specially constructed for each particular application.

In accordance with the present invention, an album is provided in which the album book block comprises two basic parts. The first part is a base tab which is permanently bound to other base tabs along the spine of the album cover assembly to hold the album pages in place. The base tab does not provide the portion of the album page on which the photograph is displayed, but only provides a tab which extends from the album spine. The second part of the book block is a page assembly which conforms to the dimensions of the album covers and provides the surface for mounting the photograph or other object which is displayed on the album page. The page assembly has at least three layers—two outer layers and an inner layer which forms a pocket into which the base tab is inserted and locked. The tab and the page pocket each include a keyed portion that locks the page assembly to the tab to secure the page into place, and, in turn, secure the album pages to the album binding.

Each of the page assemblies may be provided with different arrangements and designs. The album construction of the present invention allows the photographer or other person assembling the album to have complete flexibility in the order in which photos are arranged in the album, by simply choosing the desired page, slipping it onto the desired base tab, and locking it in place.

The attachment of the page assembly to the base tab is contained completely inside the layers of the page assembly and is unseen to anyone viewing the finished album. The album thus presents the appearance of a bound album that has been specially manufactured for that particular presentation, since there is no apparent evidence that the page assembly was attached to the album core after the album binding was completed. The album of the present invention thus avoids the intricate exposed binding constructions of the prior art which detracted from the appearance of the album.

In the event that a page assembly is spoiled or assembled incorrectly, the undesired page assembly can be removed from the bound album and replaced by another page assembly by unlocking the page assembly from the base tab. The undesired page assembly can then be removed, and a different page can be installed in its place, while the remainder of the album is preserved. The Slip-Lock arrangement of the present invention allows any of the page assemblies to be replaced as needed or desired.

These and other advantages are provided by the present invention of a photograph album comprising: a cover assembly, a plurality of base tabs, and a plurality of page assemblies. The cover assembly comprises front and back covers. The base tabs are bound and attached to the cover assembly, and each of the base tabs has a support portion. The page assemblies are attached to the base tabs, with each of the page assemblies having a pocket adapted to receive the support portion of one of the base tabs and to lock the page assembly to the base portion.

### BRIEF DESCRIPTION OF THE DRAWINGS

FIG. 1 is a perspective view of an album incorporating the present invention.

FIG. 2 is an elevation of one of the pages of the album of FIG. 1 before the page assembly has been slipped on and locked to the base tab, with one of the outer layers of the page assembly removed to show the inner pocket into which the support portion of the base tab is inserted.

FIG. 3 is an exploded elevation of the base tab of FIG. 2, showing the layers of the base tab, and showing the means by which the base tabs are attached to each other.

FIG. 4 is an elevational view of the first layer of the base tab of FIG. 3 prior to its folding.

FIG. 5 is an exploded elevation of the Slip-Lock page assembly of FIG. 2, showing the layers of the page assembly.

### DETAILED DESCRIPTION OF THE PREFERRED EMBODIMENT

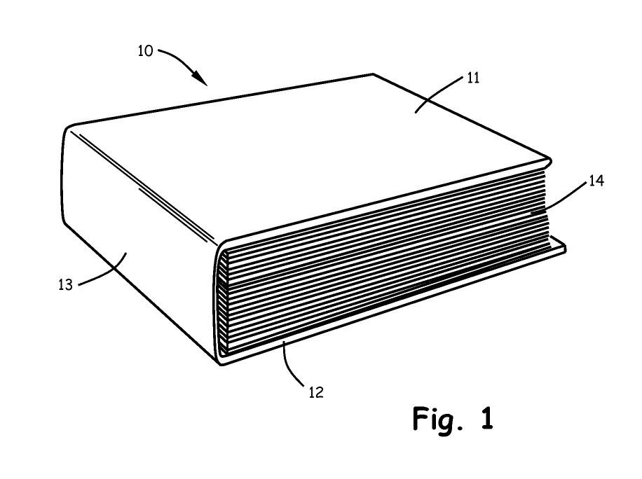

Referring more particularly to the drawings, and initially to FIG. 1, there is shown an album 10 according the present invention. The album comprises a cover assembly comprising a front cover 11 and a back cover 12, and a spine 13 connecting the front and back covers together. Between the covers is a plurality of tabs and pages making up the book block 14 bound together along the inner portions of the tabs and pages adjacent to the spine 13 of the album. The album cover assembly may be made of any suitable material, and may be made of leather to provide a quality look and feel to the finished album. The front cover 11 of the album may be decorated with a title or a pattern or may be provided with an opening for a special photograph or other graphic.

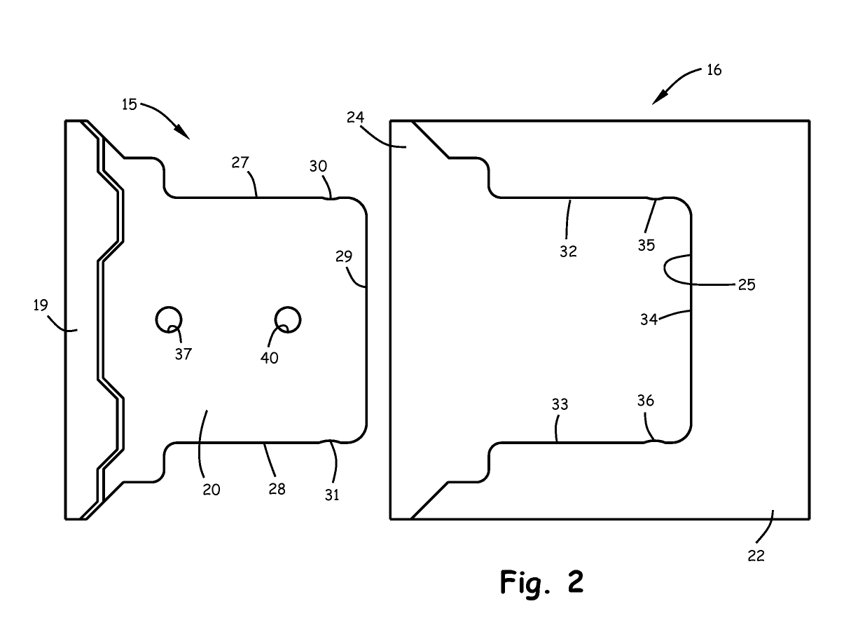

The assembled book block 14 of FIG. 1 comprises two parts-a base tab 15 and a page assembly 16, as shown in FIG. 2. A plurality of the base tabs 15 is permanently bound together as hereafter described into the album cover assembly, and one of the page assemblies 16 is attached to each of the base tabs 15 to form the finished album.

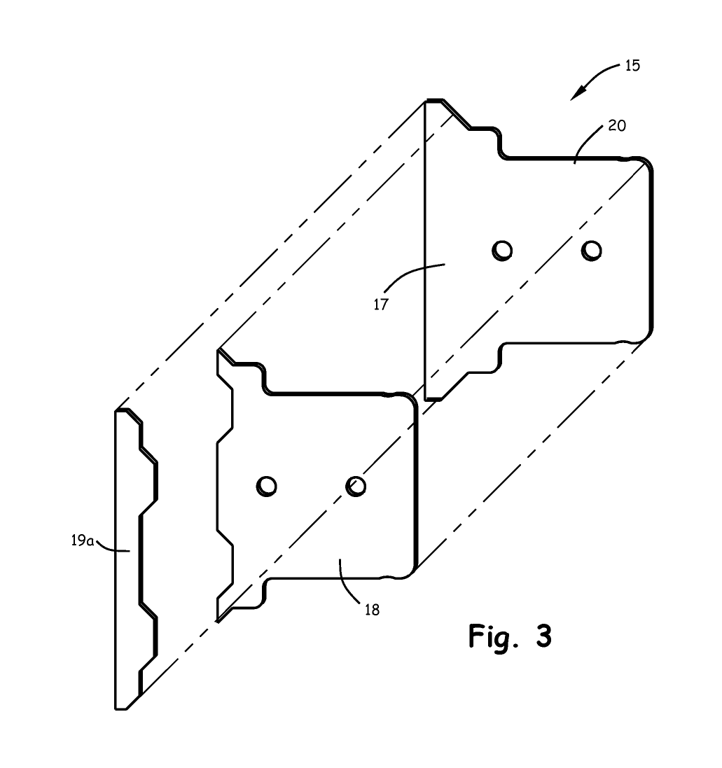

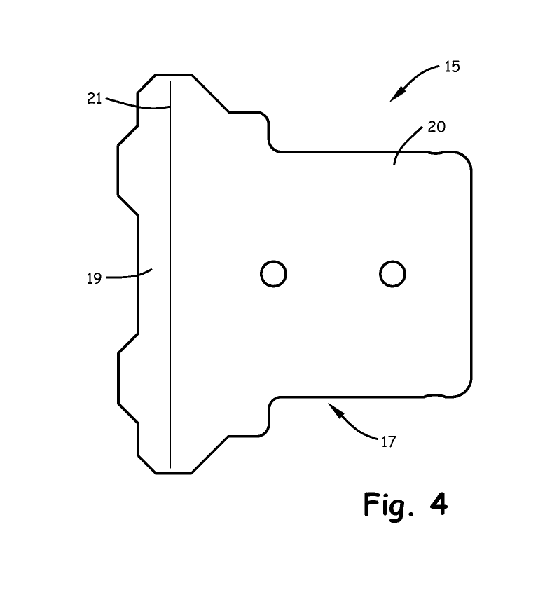

One of the base tabs 15 is shown in more detail in FIG. 3. The base tab 15 comprises a first layer 17 and a second layer 18, each made of suitable construction material such as mat-quality paper board. The first layer 17 of the base tab is initially formed by die cutting, as shown in FIG. 4, with a binding portion 19 at one end, a support portion 20 at the other end, and a laterally extending crease 21 for folding the first layer between the two portions 19 and 20. The support portion 20 has a unique profile which will be discussed in detail below with respect to its interconnection with the page assembly. After folding the first layer 17 along the crease 21, it is glued to another first layer as shown in FIG. 3, with the binding portion 1 9a of the first layer glued onto the adjacent inner edge of the support portion 20 of the next first layer. Then the second layer 18 is glued onto the support portion 20 of the first layer, so that each of the base tabs 15 has a uniform thickness. As shown, the second layer 18 has an outer profile that matches the outer profile of the support portion of the first layer 17, so that the support portion 20 of the base tab is essentially two layers thick.

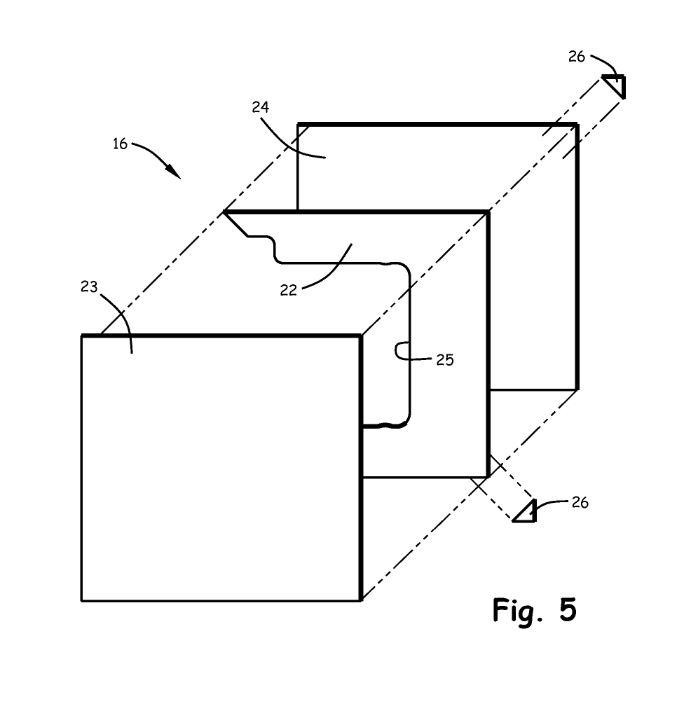

Each of the page assemblies 16 is also formed of a plurality of layers as shown in FIG. 5. An inner layer 22 is formed, such as by die cutting, with a unique profile which is the complement of the corresponding profile of the support portion 20 of the base tab. A pair of outer layers 23 and 24 is glued on each side of the inner layer 22 to form a pocket 25 between the outer layers, with the edges of the pocket defined by the inner profile of the inner layer. Photographs or additional paper layers may be glued onto the outside surfaces of each of the outer layers 23 and 24 prior to assembly to provide desired finished appearance to album page.

If desired, metal corner protectors 26 may also be placed around each outer corner of the outer layers to protect each of the album pages.

The base tab 15 and the page assembly 16 are designed to interlock with each other as shown in FIG. 2, which depicts one of the base tabs prior to being assembled with a page assembly, and with one of the outer layers 23 of the page assembly removed to reveal the configuration of the inner pocket 25. The outwardly extending end of the base tab has a generally rectangular shaped support portion 20 having parallel outwardly extending top and bottom edges 27 and 28 and a straight side edge 29, with rounded corners between the top and bottom edges and the side edge. Adjacent to the side edge 29, the top edge 27 and the bottom edge 28 each have a small rounded indention 30 and 31. The pocket 25 formed by the inner layer 22 of the page assembly has a complementary configuration with a generally rectangular shaped pocket portion for receiving the support portion 20 of the base tab. The pocket 25 includes parallel top and bottom edges 32 and 33 with a straight inside edge 34 between the top and bottom edges and with rounded corners between the edges. Along each of the top and bottom edges 32 and 33 adjacent to the inside edge 34 is a small rounded hump 35 and 36, each designed to engage one of the indentations 30 and 31 on the support portion of the base tab. The engagement of the humps 35 and 36 into the indentations 30 and 31 effectively locks the page assembly 16 onto the base tab 15 when the page assembly is slipped onto the base tab and the support portion 20 is fully inserted into the pocket 25. The engagement is very effective, but the page assembly 16 can be removed from the base tab 15 by firmly pulling the page assembly from the base tab.

The support portion also has a pair of holes 37 and 38. The purpose of the holes is to maintain registration of the support portion 20 to the second layer 18 while keeping the spine assembly square.

The assembly of the album 10 of the present invention begins with the production of the various layers of the base tabs 15 and the page assemblies 16. The layers are made from suitable quality paper board products which are well known in the manufacture of other photo albums and photo mounts. The layers may be produced in the desired shapes by die cutting or other suitable process. Each of the first layers 17 of the base tabs 15 is formed as shown in FIG. 4, and each of the first layers is folded along the crease 21. The second layer 18 of each of the base tabs 15 is glued onto the support portion 20 of the first layer 17 as shown in FIG. 3. Then all of the base tabs 15 are glued together, by gluing the binding portion 19 of each first layer 17 onto the adjacent portion of the next base tab as shown in FIG. 3 using the pair of holes 37 and 38 as a guide to keep the tabs square to the spine. The assembly of base tabs 15 is then attached to the album cover assembly by gluing the end base portions onto the inside of the front and back covers 11 and 12. A cover lining is provided on the inside of the front and back covers to hide the attachment of the base portions to the covers. The resulting assembly forms the core of the photo album. Various page assemblies 16 are made by die cutting or otherwise forming the inner layer 22, making the outer layers 23 and 24 and gluing the layers together as shown in FIG. 5.

The album core is provided to the photographer or other person who is responsible for assembling the final album. The final album assembly may be completed by the purchaser of the album core or by any other person who is aware of the desired final design of the album. Along with the album core, the final assembler is provided with a plurality of page assemblies 16, which are used as Slip-Lock pages for the album. The Slip-Lock pages 16 may be of different colors and sizes, and they may be designed for the mounting of a single photograph or of multiple items. The photographs or other items are mounted on the exterior surfaces of the outer layers 23 and 24 of the Slip-Lock pages 16 prior to assembly into the album. It can be seen that the final album assembly can vary widely depending upon the needs of the person assembling the album, the purpose for which the album is assembled, and the material to be mounted in the album.

If during the assembly of the album, a page assembly 16 is installed in the wrong location in the album, or one of the page assemblies is spoiled due to a mounting error, the page assembly can be removed from the album by firmly pulling the page assembly to unlock the page assembly from the base tab. The remainder of the album will remain unspoiled, thus saving the work already accomplished and the expense of a new album cover and core.

Since the connection between the base tab 15 and the page assembly 16 is contained within the pocket 25 on the inside of the page assembly, this connection is completely hidden from anyone viewing the album. The result is that the album 10 gives the appearance of a bound album specially constructed for the particular application, rather than one of an album that has been mass produced. The hidden nature of the Slip-Lock system connecting between the base tab 15 and the page assembly 16 is also achieved by selecting each of the layers so that they fit together in the desired manner. In particular, the two layers 17 and 18 of the base tab should match the thickness of the inner layer 22 of the page assembly, so that when the support portion 20 is inserted into the pocket 25, the resulting assembly has a uniform thickness.

It should be realized that the embodiment described herein is only representative of the invention and is not intended to limit the invention to one particular embodiment as the invention includes all embodiments falling within the scope of the appended claims. Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A photograph album comprising:
a cover assembly comprising front and back covers;
a plurality of base tabs bound and attached to the cover assembly, each of the base tabs having a support portion;
a plurality of page assemblies for attachment to the base tabs, each of the page assemblies having a pocket adapted to receive the support portion of one of the base tabs and to lock the page assembly to the base portion.

2. A photograph album as provided in claim 1, wherein the cover assembly includes a spine where the front and back covers are joined, and the base tabs are bound together along an inner edge adjacent to the spine.

3. A photograph album as provided in claim 1, wherein each of the base tabs and each of the page assemblies have locking portions which engage each other to secure the page assembly to the base tab.

4. A photograph album as provided in claim 3, wherein the locking portion is hidden from view when the page assembly is attached to the base tab.

5. A photograph album as provided in claim 3, wherein the locking portion allows the page assembly to be removed from the base tab.

6. A photograph album as provided in claim 1, wherein each of the page assemblies comprises an inner layer and two outer layers on each side of the inner layer, the inner layer forming the pocket.

7. A photograph album as provided in claim 5, wherein each of the page assemblies is attached to one of the base tabs by inserting at least a portion of the base tab into the pocket.

8. A photograph album comprising:
a cover assembly comprising a front cover, a back cover, and a spine connecting the front and back covers; and
a plurality of album pages bound to the cover assembly, each of the pages comprising
a base tab bound together along one edge to other base tabs and attached to the cover assembly, the base tab having a support portion, the support portion having a locking portion;
a page assembly adapted to be attached to the base tab, the page assembly having a pocket into which the support portion of the base tab is inserted when the page assembly is slipped onto the base tab, the pocket having a locking portion which engages the locking portion of the support portion to securely hold the page assembly to the base tab.

9. A photograph album as provided in claim 8, wherein the base tabs are bound together along an inner edge adjacent to the spine.

10. A photograph album as provided in claim 8, wherein the locking portion on the support portions comprises an indentation and the locking portion on in the pocket comprises a hump which is inserted into the indentation to secure the page assembly to the base tab.

11. A photograph album as provided in claim 10, wherein the indentation and the hump are both rounded to allow the hump to slide into the indentation.

12. A photograph album as provided in claim 8, wherein the locking portion is located inside the page assembly when the page assembly is attached to the base tab.

13. A photograph album as provided in claim 8, wherein the page assembly comprises an inner layer and two outer layers, one on each side of the inner layer, the inner layer forming the pocket.

14. A photograph album as provided in claim 13, where the base tab comprises a support portion which extends from the spine, the support portion having side edges, the locking portion being formed on the side edges of the support portion.

15. A method for making a photograph album comprising the steps of:
assembling an album core comprising a front cover, a back cover, a spine connecting the front and back covers, and a plurality of album base tabs bound to the front and back covers, each of the base tabs having a support portion, the support portion having a locking portion;
providing a plurality of page assemblies, each of which is adapted to be slipped onto one of the support members to form an album page;
selecting the desired page assemblies and the order in which they will appear in the album; and
attaching the selected page assemblies to the album core in the selected order by slipping each of the page assemblies onto one of the support portions.

16. A method for making a photograph album as defined in claim 15, wherein the album core that is assembled includes base tabs that have outwardly extending support portions that include locking portions onto which corresponding locking portions of the page assemblies engage to secure each page assembly to the support member.

17. A method of making a photograph album as defined in claim 15, comprising the additional step of removing one of the page assemblies from one of the base tabs, and replacing it with another of the page assemblies.
